(19) United States
(12) Patent Application Publication
(10) Pub. No.: US 2002/0067509 A1
(43) Pub. Date: Jun. 6, 2002

(54) Method, apparatus and system for dynamic switching of image processing techniques

(76) Inventor: Eugene A. Roylance, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/730,719

(22) Filed: Dec. 6, 2000

(51) Int. Cl. H04N 1/409; H04N 1/40; G06K 9/64; G06K 15/02; G06T 5/00

(52) U.S. Cl. 358/2.1; 358/3.27; 382/217; 358/1.2; 382/254

(57) ABSTRACT

The present invention is methods, apparatuses and systems for dynamic switching of image processing techniques. Image processing techniques include resolution enhancement for improving the quality of text and line art, halftone image enhancement for improving the quality of gray value or halftone images and toner conservation for reducing toner consumption. Toner conservation may be used simultaneously with other image enhancement processing techniques according to the present invention.

### FIELD OF THE INVENTION

The present invention relates generally to imaging systems, pixel resolution enhancement and toner saving methods as used with image processing systems. More particularly, the present invention relates to methods, apparatuses and systems for dynamically applying image processing techniques for reproducing text, line art and halftone images.

### BACKGROUND OF THE INVENTION

Electrophotographic processes for producing a permanent image on media are well known and commonly used. A common process includes: (1) charging a photoreceptor such as a roller or continuous belt bearing a photoconductive material; (2) exposing the charged area to a light image to produce an electrostatic charge on the area in the shape of the image; (3) presenting developer particles (toner) to the photoreceptor surface bearing the image so that the particles are transferred to the surface in the shape of the image; (4) transferring the particles in the shape of the image from the photoreceptor to the media (e.g., paper); (5) fusing or fixing the particles in the shape of the image to the media; (6) cleaning or restoring the photoreceptor for the next printing cycle. The process described is utilized by many conventional image forming apparatuses such as laser printers, copy machines and facsimile machines.

In laser printers, an image is typically rasterized to form a bit pattern which is stored as a binary image bitmap for subsequent rendering to a final output image. The image bitmap is also referred to as a picture element (“pixel”) raster image. In the rasterizing process (i.e., forming the binary bitmap), graphic elements, such as continuous lines (line art) and text character outlines are converted to pixel patterns that approximate the source image shape. Continuous tone data, such as photographic data (both color and gray value images) are also converted to pixel patterns that approximate the source continuous tone image data.

However, to effectively portray the original source image for halftone or continuous tone data, each pixel of the source image must be represented by multiple bits which define either a color or a gray level and which are subsequently converted, typically, to a binary image bitmap. The term “gray”, as used herein, applies to both color images and black/white images. The term “gray” when applied to color images herein relates to the intensity of the color.

Conventionally, in order to represent gray level images on a bi-level (black and white) printer, the pixel data, if not already gray level, is converted into a gray level, multi-bit configuration. For example, when a multi-bit configuration of 8 bits per pixel is employed, 256 gray levels can be represented by the digital pixel values. The individual gray level pixels are converted to binary level pixels (i.e., bi-level data for subsequent rendering) through the use of a dithering process. Spatial dithering (or digital halftoning) is the converting of the multi-bit pixel values (of a source image) to fixed-size, binary, multi-pixel groupings that approximate the average gray value of the corresponding source data. This dithering process provides a halftone texture to selected areas of the image so as to provide gray value variations therein. Thus, for example, with binary pixels, a 6×6 multi-pixel grouping can, in theory, simulate 36 levels of gray, and an 8×8 grouping can simulate 64 levels.

The dithering process employs a comparison of the individual pixel values (specified by a source image intensity array) against a threshold matrix (dither matrix or device best threshold array) to control the conversion of the gray level values to appropriate patterns of bi-level data. For purposes of this discussion, a gray level value of 255 in a source image is considered to be “white” and a gray level value of 0 is “black”. The threshold matrix comprises a plurality of row-arranged gray level values which control the conversion of the gray level pixel values to bi-level pixel values which are stored in a resultant page buffer array (raster) bitmap. During the dithering process, the threshold matrix is tiled across the image pixels to enable each gray level image pixel to be compared against the correspondingly, logically-positioned gray level value of the threshold matrix. In essence, each entry in the threshold matrix is a threshold gray level value which, if exceeded by the source image gray level pixel value, causes that gray level image pixel to be converted to a “white” pixel (or a binary logical “zero”). If, by contrast, the source image gray level pixel value is less than or equal to the corresponding threshold matrix gray level value, it is converted to a “black” pixel (or a binary logical “one”, i.e., a complementary or opposite pixel value relative to “zero”).

The above discussion has focused on the differences between rasterizing text (or line art) and halftone images (pictures). However, in either case, once a raster page buffer array bitmap is generated from a source image, whether the image is text, line art, or halftone, the desired output image is created (rendered) by causing a laser to be modulated in accordance with the bit pattern stored in the image page buffer array bitmap. The modulated laser beam is scanned across a charged surface of a photosensitive drum in a succession of raster scan lines. Each scan line is divided into the pixel areas and the modulated laser beam causes some pixel areas to be exposed to a light pulse and some not, thus causing a pattern of overlapping pixels on each scan line. Where a pixel area is illuminated, the photosensitive drum is discharged, so that when it is subsequently toned, the toner adheres to the discharged areas and is repelled by the still charged areas. The toner that is adhered to the discharged areas is then transferred to the media (paper) and fixed in a conventionally known manner.

Generally, the fidelity of the output image relative to the source data is directly related to the resolution of the pixels (dots) in the output image. Arbitrary analog images cannot be exactly reproduced by a bitmap raster. For example, as a result of the pixel configuration of the image, image edges that are either not parallel to the raster scan direction or not perpendicular to the raster scan may appear stepped. This is especially noted in text and line art.

Various techniques have been developed to improve the quality of the output image of a raster bitmap. These enhancement techniques include: edge smoothing, fine line broadening, antialiasing (to smooth jagged edges), and increasing resolution. These enhancing techniques typically modify the signals to the laser to produce smaller dots that are usually offset from the pixel center, or in other words, to produce gray scale dots. However, most of the enhancing techniques operate on the image data after it has already been rasterized, and hence, after the fine detail has already been lost. Thus, most enhancing techniques employ interpolation methods upon the raster data to “best” render the image.

An example of one of the more widely used edge smoothing techniques to improve the quality of the output image of a raster bitmap is disclosed in U.S. Pat. Nos. 4,847,641 and 5,005,139 both to Tung, the disclosures of which are incorporated herein by reference for all purposes. Tung discloses a character generator that produces a bitmap of image data and inputs that bitmap into a first-in-first-out (FIFO) data buffer. A fixed subset of the buffer stored bits forms a sampling window through which a selected block of the bitmap image data may be viewed (for example a 9×9 block of pixels with the edge pixels truncated). The sampling window contains a center bit cell which changes on each shift of the image bits through the FIFO buffer. As the serialized data is shifted, the sampling window views successive bit patterns formed by pixels located at the window's center bit cell and its surrounding neighbor bit cells. Each bit pattern formed by the center bit and its neighboring bits is compared in a matching network with pre-stored templates. If a match occurs, indicating that the center bit resides at an image edge and that the pixel it represents can be altered so as to improve the image's resolution, a modulation signal is generated that causes the laser beam to alter the center pixel configuration. In general, the center pixel may be made smaller than a standard unmodified bitmap pixel and is possibly moved within the confines of the pixel cell. For a laser printer, the pixel size alteration may be carried out by modulating the laser contained in the “laser print engine” of the laser printer. The teachings of Tung are now generally referred to as Resolution Enhancement Technology (RET), and are particularly adapted to improving image resolution for text and line art.

Although conventional RET techniques work well for edge smoothing of text and line art images, RET is not intended for application on halftone images. This is because in halftone images there typically are no discrete “edges” that require smoothing. Thus, when complex images that include text, and/or line art, and halftone are processed through RET, the text or line art is enhanced (edges are smoothed) but the halftone image quality may in fact be diminished. The term “complex bitmap image” and “complex image” are used synonymously herein and refer to an image that may include any combination of text, line art and halftone imagery on a single page. The high frequency nature of any halftone image, i.e., the black to white transitioning, may especially be undesirably altered as a result of RET. This is because RET is conventionally applied to the entire raster image, regardless of whether the data (pixel pattern) is representative of text, line art, or halftone images.

One approach to solving the problem of image enhancement in the presence of text and/or line art and halftone is disclosed in U.S. Pat. No. 5,987,221 to Bearss et al. In Bearss et al., text and line art image data is distinguished from halftone image data for selectively enhancing the complex image. More specifically, Bearss et al. discloses a method of rendering a raster pixel image from a stored bitmap including determining whether an orphan pixel is detected within a bounded sampling window of the bitmap, and processing at least one selected pixel of the bitmap within the sampling window relative to the determining of whether an orphan pixel is detected. An orphan pixel is defined as an isolated white or black pixel in a halftone image.

Another approach to improving the quality of printer images is known as “resolution doubling” as disclosed in U.S. Pat. No. 5,929,892 to Towner et al. and U.S. Pat. No. 5,920,336 to Lawton et al., the disclosures of both of which are incorporated herein by reference for all purposes. More specifically, Lawton et al. discloses a system and method whereby the laser beam is borrowed (deflected) from a white space area adjacent an image to double resolution at the edges of the image. Towner et al. discloses a system and method of providing a periodic trajectory scan path for a laser beam across a photoconductive surface in a laser printer. In a preferred embodiment of the periodic trajectory for a system with a two-axis deflector includes a multiple-frequency omega wave trajectory for providing a substantially rectangular grid of available dot locations for selective laser beam pulsing. The plurality of generally linear rows of dots are completed in a single scan pass of the laser beam across the photoconductive surface. The periodic trajectory is provided by deflecting the laser beam with an optical beam deflector, such as an electro-optic deflector placed between the laser and the rotating polygon scanning mirror.

Additional resolution enhancement techniques are disclosed in U.S. Pat. No. 5,515,480 to Frazier and U.S. Pat. Nos. 5,193,008 and 5,134,495, both to Frazier et al., the disclosures of which are incorporated herein by reference for all purposes. These Frazier et al. patents disclose methods of modulating laser pulses to form dots of different sizes, shapes and positions, including interleaving of dots between scan lines of the print engine.

Halftone image enhancement techniques are also known in the art. For example, and not by way of limitation, U.S. Pat. No. 5,898,505 to Lin et al. discloses a method for producing halftone images via a multi-stage dither procedure, the disclosure of which is incorporated herein by reference for all purposes.

In addition to improving the quality of printer images, printer manufacturers are continually faced with reducing the cost of outputting a printed page. One of the significant costs of operating a laser printer is the cost of toner material. Various approaches to conservation of toner have been developed particularly where the output image quality is not important, such as for draft copies of documents. The basic idea behind toner conservation technology is to reduce the amount of toner used in dark portions of an image.

One approach to reducing the cost of operating a laser printer by conserving toner is disclosed in U.S. Pat. No. 5,630,026 to Ogletree et al., the disclosure of which is incorporated herein by reference for all purposes. The method and apparatus disclosed in Ogletree et al. in essence describes scanning a window with a center pixel across a bit pattern representing the image to be printed. In the case where all pixels within the scanning window are black the center pixel is changed to white when printed to conserve toner. In the case where any pixel is white the center pixel remains unchanged when printed. The effect is a dark border around what would otherwise be a solid black object, ie., the solid black object is “hollowed out”.

Another approach to reducing the cost of operating a laser printer by conserving toner is disclosed in U.S. Pat. Nos. 5,729,270 and 5,986,681, both to Wright et al., the disclosures of which are incorporated herein by reference for all purposes. More specifically, one embodiment of Wright et al. discloses portioning each conventional 300 dpi pixel vertically, and selectively illuminating one or more of the vertical portions of each portioned pixel to reduce toner usage. Another embodiment disclosed in Wright et al. is to reduce the size of a conventional dot from 300 dpi to a smaller size by modulation to again reduce toner usage.

However, one problem with conventional toner conservation image processing techniques is that when selected, the image enhancement techniques available to improve image quality, such as resolution enhancement technology for smoothing edges in text and line art, and halftone enhancement technology for improving grayscale images are turned off. While this may be acceptable for some draft quality documents, it would be preferable to have improved image quality even while reducing toner consumption.

The above described image processing techniques for improving image quality and reducing printing costs work well on larger images of a set resolution and bit depth. However, for complex pages that have combinations of text or line art and halftone images it is desirable to use resolution enhancement technology to smooth jagged edges on text or line art, halftone image enhancement technology to improve the halftone images and toner conservation image processing techniques where desired to reduce the cost of operation of a laser printer.

Conventional technology may allow the reduction of toner usage but not simultaneously with halftone image enhancement. Similarly, conventional technology allows halftone image enhancement and resolution enhancement technologies to improve grayscale images and text or line art, respectively, according to data content, but there is no current capability to allow for switching of halftone, text and line art and toner conservation processing techniques simultaneously for complex images. Therefore, there exists a need in the art for methods, apparatuses and systems that allow for dynamic switching between resolution enhancement technologies for text and line art, halftone image enhancement technologies for grayscale images and toner conservation for dark portions of images where desired.

### SUMMARY OF THE INVENTION

The present invention is methods, apparatuses and systems for dynamic switching of image processing techniques. Image processing techniques include resolution enhancement for improving the quality of text and line art, halftone image enhancement for improving the quality of gray value or halftone images and toner conservation for reducing toner consumption. Toner conservation may be used simultaneously with other image enhancement processing techniques according to the present invention.

A method of printing a complex bitmap image according to the present invention includes providing a superset of image processing templates configured for a plurality of image enhancement procedures, storing the complex bitmap image at a bit depth suitable for processing by all of the plurality of image enhancement procedures, windowing the superset of image processing templates over the stored complex bitmap image to identify regions in the complex bitmap image suitable for processing by one or more of the plurality of image enhancement procedures, selectively applying one or more of the plurality of image enhancement procedures to the identified regions to enhance a raster image of the complex bitmap image, and printing the enhanced raster image.

An apparatus for enhancing complex bitmap images according to the present invention includes a memory for storing gray value image data, a multiplexer with multiple inputs, a single output and a selection line, text and line art enhancement circuitry coupled between the memory and a first of the multiple inputs of the multiplexer, halftone image enhancement circuitry coupled between the memory and a second of the multiple inputs of the multiplexer, toner conservation circuitry coupled between the memory and a third of the multiple inputs of the multiplexer, and enhancement mode selection circuitry coupled between the memory and the selection line of the multiplexer for selectively engaging the text and line art enhancement circuitry, the halftone image enhancement circuitry and the toner conservation circuitry.

A laser printer according to the present invention includes a bus, a processor connected to the bus, a laser print engine connected to the bus, and a first memory device comprising a halftone procedure, a text and line art procedure, a toner conservation procedure, a resolution enhancement procedure, a halftone enhancement procedure, and a dynamic switching procedure for dynamically selecting and nonexclusively applying the toner conservation procedure, the resolution enhancement procedure and the halftone enhancement procedure to a complex bitmap image.

These methods, apparatuses and systems of the present invention will be readily understood by reading the following detailed description in conjunction with the accompanying figures of the drawings.

### DESCRIPTION OF THE DRAWINGS

In the drawings, which illustrate what is currently regarded as the best mode for carrying out the invention and in which like reference numerals refer to like parts in different views or embodiments:

FIG. 1 is a block diagram of a laser printer incorporating the dynamic switching of image enhancement modes of the present invention.

FIG. 2 is a block diagram illustrating dynamic switching of image enhancement modes for a laser printer in accordance with the present invention.

FIG. 3 is a flow chart of a method of dynamically switching image enhancement modes for a laser printer according to the present invention.

### DETAILED DESCRIPTION OF THE INVENTION

The invention includes methods, apparatuses and systems for dynamically switching between a plurality of image processing techniques based on the image data and the user needs. For convenience only, a laser printer will be used as the exemplary image forming apparatus described herein. However, one of skill in the art will recognize that the inventive methods, apparatuses and systems described herein are also applicable to copy machines and facsimile machines as well as laser printers. The terms “image processing techniques”, “image processing procedures” and “image processing modes” are used interchangeably herein and refer to the conventional text and/or line art image enhancement techniques (e.g., resolution enhancement technology), halftone image enhancement techniques, resolution doubling image enhancement techniques and toner conservation techniques described above. The term “image processing template”, as used herein, refers to a two-dimensional pattern of image pixels used to identify a region of an image that may be enhanced by an associated image enhancement procedure. The term “windowing”, as used herein, refers to the act of comparing a given image processing template to an image to identify matching regions suitable for processing by an image enhancement procedure.

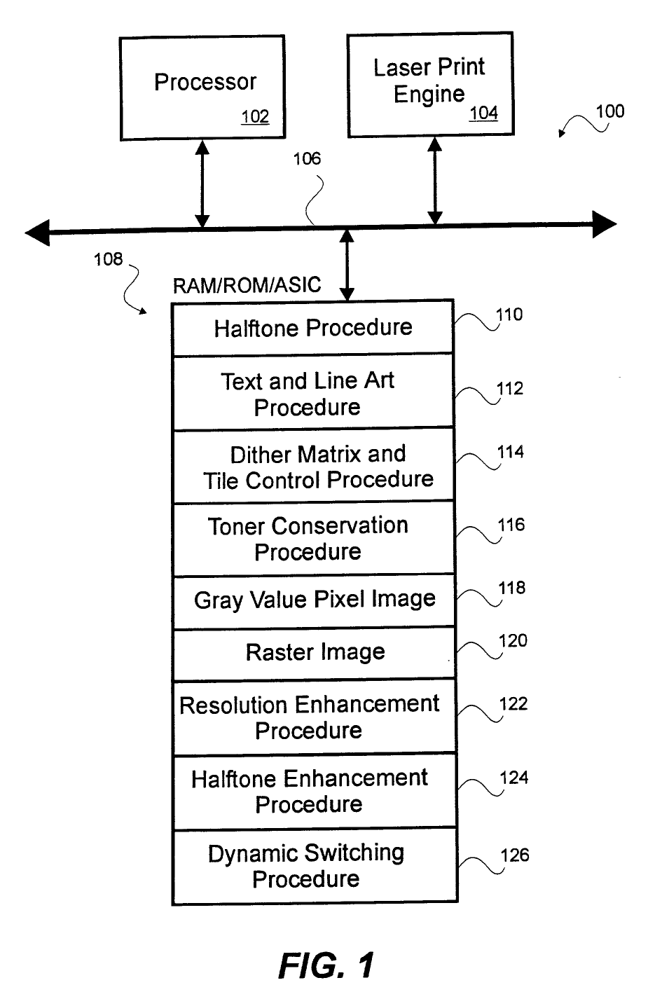

FIG. 1 is a block diagram of a laser printer 100 that incorporates the dynamic switching of image processing techniques of the present invention. Laser printer 100 includes a processor 102 and a laser print engine 104, interconnected via a bus 106. A read only memory (ROM) and/or random access memory (RAM) and/or application-specific integrated circuit (ASIC) 108 is/are connected to the bus 106. For simplicity of illustration and discussion purposes, ROM/RAM/ASIC or “memory device” 108 is shown as a single block unit although, as is well known in the art, each are generally separate units for providing specific functionalities. It is also to be understood that the rendering or rasterizing procedures and data discussed herein for laser printer 100 may be maintained and utilized as control firmware in any conventional ROM, and/or implemented in an ASIC for high-speed hardware functionality, and/or implemented in connection with RAM for storage and buffering purposes. Processor 102 may be a complex instruction set computer (CISC) microprocessor or a reduced instruction set computer (RISC) microprocessor as known in the art. A “procedure”, as defined herein, includes computer instructions (software or firmware) configured for execution by processor 102, or alternatively, hard coded digital logic that may be resident in an ASIC.

Memory device 108 includes procedures and data necessary to perform the rasterizing, halftoning, rendering and dynamic switching functions of the present invention. Alternatively, memory device 108 includes the procedures and data necessary to enable processor 102 to perform the rasterizing, halftoning, rendering and dynamic switching functions of the present invention. More specifically, memory device 108 includes a halftone procedure 110, a text and line art procedure 112, a dither matrix and tile control procedure 114, a toner conservation procedure 116, a gray value pixel image 118 (as received from a host processor, not shown) which is to be altered by the invention into a raster image 120, suitable for rendering by the laser print engine 104. Raster image 120 may be buffered in RAM or fed directly from an ASIC to the print engine 104. Resolution enhancement technology (RET) procedure 122 provides edge smoothing for text and line art stored within raster image 120 upon final rendering. Halftone enhancement procedure 124 provides image enhancement to gray scale image data. Dynamic switching procedure 126 includes rules for intelligently selecting between all available image processing procedures, i.e., halftone procedure 110, text or line art procedure 112, dither matrix and tile control procedure 114, toner conservation procedure 116 and resolution enhancement procedure 122.

Gray value pixel image 118 is of the conventional type wherein each pixel is represented by a multi-bit gray value. If gray value pixel image 118 is a color image, it will generally comprise four color planes with three of the color planes representing cyan, magenta and yellow color values (or red, green and blue color planes). Moreover, each color value in each plane may be represented by a predetermined number of bits, e.g., by 8 bits. A fourth plane, representing black, may be comprised of a single or multiple bit values at each pixel location where a black or gray scale image value is to appear on the finally rendered output. Thus, there may be a total of 25 to 32 bits per pixel in a gray value pixel image 118, if color is embodied. On the other hand, if the gray value pixel image 118 is a non-color (black and white or gray scale) image, each pixel may, for example, be represented simply by 8 bits to depict 256 levels of gray as well known in the art. Other bit depths and color planes, such as in high-fidelity printing, are equally applicable in the present invention, as will be obvious to those of ordinary skill in the art.

Halftone procedure 110 and dither matrix and tile control procedure 114 are used to convert any continuous tone image within gray value pixel image 118 into a halftoned raster image 120. Text and line art procedure 112 converts text and line art images within gray value pixel image 118 in to raster image 120. Halftone images may be distinguished from text and line art images using window templates to identify orphan pixels as disclosed in U.S. Pat. No. 5,987,221 to Bearss et al. Resolution enhancement procedure 122 smooths edges in a given image. Resolution enhancement procedure 122 may include the methods disclosed in U.S. Pat. Nos. 4,847,641 and 5,005,139 both to Tung. Resolution enhancement procedure 122 may include the methods disclosed in U.S. Pat. No. 5,515,480 to Frazier and U.S. Pat. Nos. 5,193,008 and 5,134,495, both to Frazier et al. Toner conservation procedure 116 reduces toner usage in dark regions of images. Toner conservation procedure 116 may include the methods disclosed in U.S. Pat. No. 5,630,026 to Ogletree et al. Toner conservation procedure 116 may also include the methods disclosed in U.S. Pat. Nos. 5,729,270 and 5,986,681, both to Wright et al.

Switching between multiple image processing modes requires knowing when to select an enhancement mode to operate on the data. By providing more information (relative to conventional image processing techniques) to the data-windowing block or the two-dimensional window for templates, and providing the criteria for when each of the plurality of image processing modes are to be active, the selection process can be performed without corrupting the output of enhancement modes that might otherwise conflict. The term “superset of image processing templates” as used herein refers to a set of image processing templates that may include templates or sets of templates derived from one or more conventional image processing techniques. The superset of image processing templates according to the present invention may be capable of identifying regions of a complex bitmap image that are text and line art versus halftone as noted above. Halftone image regions so identified will not be processed by resolution enhancement technology optimized for improving the quality of text and line art. Halftone image regions so identified may be processed by halftone image enhancement processing techniques and additionally by toner conservation processing techniques. Halftone image regions including dark fill regions may be processed by toner conservation processing techniques as described above. Halftone image regions that exhibit less than full-black or dark image characteristics may also be processed to reduce toner consumption by selectively reducing dot size. Various image processing templates may be used to identify halftone image regions that are suitable for dot size reduction in halftone image regions that exhibit less than full-black, i.e., midtone regions.

Additionally, these criteria may be modified empirically to optimize print quality. For example, the superset of image processing templates according to the present invention may have programmable image processing templates. Programmable image processing templates may be able to adapt to particular image characteristics, such as for example and not by way of limitation, pixel grouping, fill regions, size and extent of particular groupings and sensitivity of particular pixel groupings to dot size reduction.

Advantages of the present invention include improving image quality while simultaneously reducing cost. By dynamically switching between a plurality of image processing techniques (i.e., resolution enhancement technology, resolution doubling, halftone image enhancement technology, etc.) to improve image quality and reduce cost (i.e., toner conservation technology in its various forms), the benefits of each image processing technique can be realized simultaneously for complex images even when toner conservation is switched on.

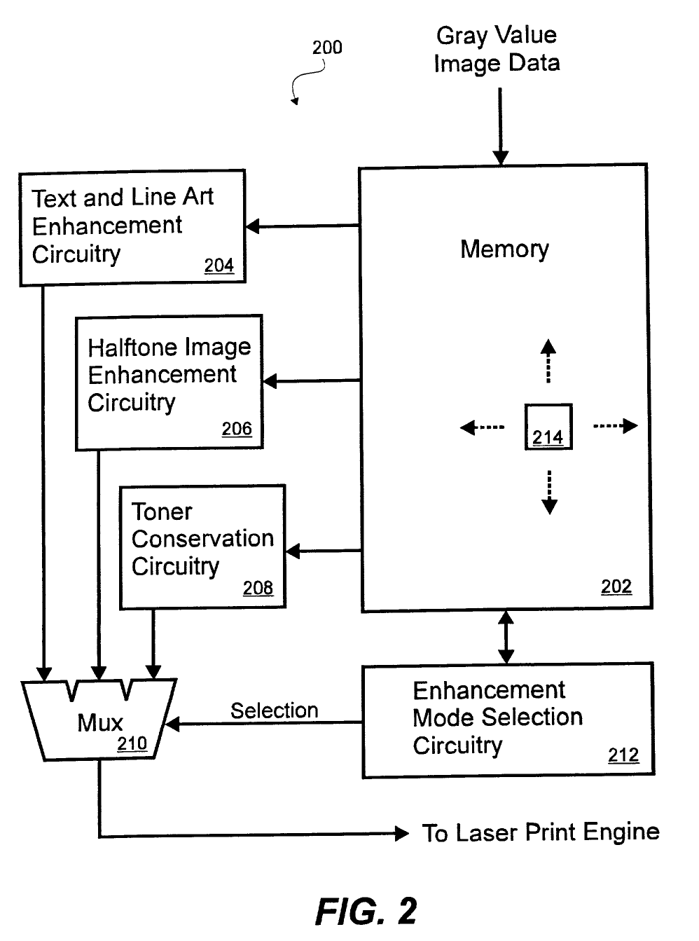

Referring to FIG. 2, a block diagram illustrating dynamic switching of image enhancement modes 200 for a laser printer is shown. The dynamic switching of image enhancement modes 200 includes a memory 202, a multiplexer 210 (MUX), text and line art enhancement circuitry 204 coupled between the memory 202 and the MUX 210, halftone image enhancement circuitry 206 coupled between the memory 202 and the MUX 210, toner conservation circuitry 208 coupled between the memory 202 and the MUX 210 and enhancement mode selection circuitry 212 coupled between the memory 202 and the MUX 210. Dynamic switching of image enhancement modes 200 may be implemented in an ASIC, or alternatively, by interconnected discrete integrated circuits. MUX 210 is illustrated in FIG. 2 as a 1-of-3 multiplexer with 3 inputs. However, any number of resolution enhancement techniques may be used consistent with the present invention. Thus, MUX 210 may have more or less than 3 inputs.

Memory 202 may be a RAM or dynamic RAM (DRAM). Memory 202 receives and stores gray value image data. The gray value image data stored is bit duplicated to the highest bit depth required by any of the image processing modes (i.e., resolution doubling, resolution enhancement, halftone image enhancement and toner conservation, etc.) for which the image data will be operated on. The term “bit depth”, as used herein, refers to the number of binary bits necessary to define a given pixel. For text or line art, a single bit may be sufficient because only black and white need be defined for each pixel. However, for halftone images multiple bits are necessary. For example, an 8-bit grayscale image may use 8 binary bits or 256 possible shades of gray running from black to white in order to define each pixel. Memory 202 may also include predefined 2-dimensional data window templates 214 that represent a superset of all image processing modes requirements, i.e., templates used to identify halftone images for halftone image enhancement, or templates used to identify text and line art images for resolution enhancement and resolution doubling, and templates used to identify dark regions for toner conservation. Alternatively, the predefined 2-dimensional data window templates may be stored in another memory device, such as disk storage, ROM, or as part of an ASIC (not shown for clarity). One ordinary skill in the art will recognize that other forms of computer data storage may be used to store the predefined 2-dimensional window templates of the present invention. The terms “predefined 2-dimensional window templates” and “template database” are used synonymously herein.

An exemplary predefined 2-dimensional data window template 214 is shown on memory 202 with dashed arrows indicating that the window is “tiled” or “windowed” over the 2-dimensional gray value image data stored in memory 202 to identify regions of the 2-dimensional gray value image data for which there is a pattern match with the template. A pattern match indicates that an enhancement can be made to the particular region in the 2-dimensional gray value image data before final printing.

Enhancement mode selection circuitry 212 dynamically selects between the text and line art enhancement circuitry 204, halftone image enhancement circuitry 206 and toner conservation circuitry 208 based on template matching using the enhanced 2-dimensional data window templates 214. When, for example, the enhanced 2-dimensional data window identifies a region in the gray value image data for which resolution enhancement can improve the quality of the image (i.e., text or line art), the data for that region is selectively processed by the resolution enhancement procedure 122 under control of the enhancement mode selection circuitry 212 before the raster image 120 is sent to the laser print engine 104. When a predefined 2-dimensional data window template 214 identifies a region in the gray value image data for which halftone image enhancement technology can improve the quality of the halftone image region, the data for that halftone image region is selectively processed by the halftone image enhancement procedure 122 under control of the enhancement mode selection circuitry 212 before the raster image 120 is sent to the laser print engine 104. Similarly, when the predefined 2-dimensional data window 214 identifies a region in the gray value image data for which the toner conservation procedure 116 can reduce toner usage (i.e., a dark region), the data for that region is selectively processed by the toner conservation procedure 116 under control of the enhancement mode selection circuitry 212.

Text and line art enhancement circuitry 204 may include the resolution enhancement techniques disclosed in U.S. Pat. Nos. 4,847,641 and 5,005,139 both to Tung. The text and line art enhancement circuitry 204 may also include the resolution enhancement techniques disclosed in U.S. Pat. 5,515,480 to Frazier and U.S. Pat. Nos. 5,193,008 and 5,134,495, both to Frazier et al. However, other resolution enhancement techniques suitable for use with the present invention are also contemplated to be within the scope of the invention. The text and line art enhancement circuitry 204 may also include the resolution doubling technology disclosed in U.S. Pat. No. 5,929,892 to Towner et al. and U.S. Pat. No. 5,920,336 to Lawton et al.

Halftone image enhancement circuitry 206 may include the halftone image enhancement technology disclosed in U.S. Pat. No. 5,898,505 to Lin et al., and/or the image enhancement technology disclosed in U.S. Pat. No. 5,987,221 to Bearss et al. However, other halftone image enhancement techniques suitable for use with the present invention are also contemplated to be within the scope of the invention.

Toner conservation circuitry 208 may include the toner conservation technology disclosed in U.S. Pat. No. 5,630,026 to Ogletree et al. or U.S. Pat. Nos. 5,729,270 and 5,986,681 both to Wright et al. However, other toner conservation techniques suitable for use with the present invention are also contemplated to be within the scope of the invention.

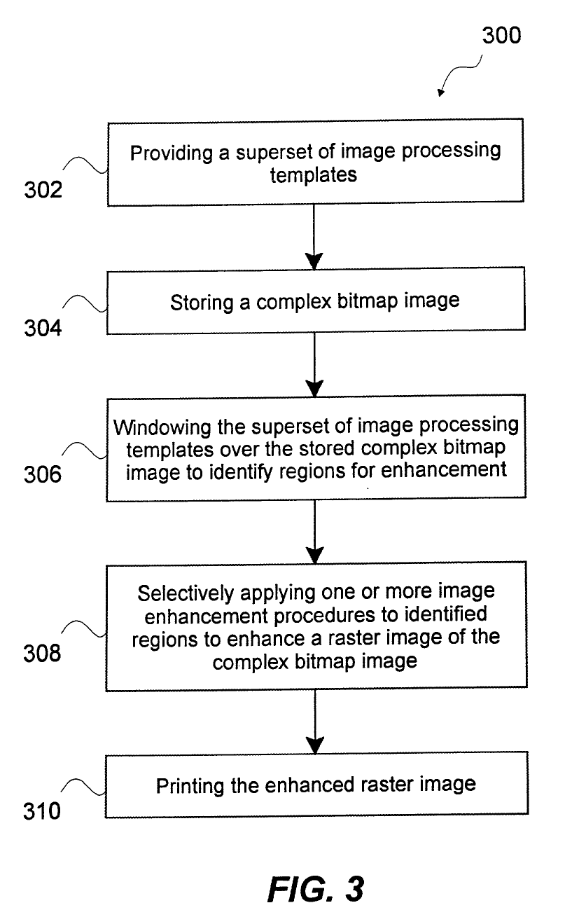

FIG. 3 is a flow chart of a method 300 according to the present invention. Method 300 includes providing 302 a superset of image processing templates configured for a plurality of image enhancement procedures; storing 304 the complex bitmap image at a bit depth suitable for processing by all of the plurality of image enhancement procedures; windowing 306 the superset of image processing templates over the stored complex bitmap image to identify regions in the complex bitmap image suitable for processing by one or more of the plurality of image enhancement procedures; selectively applying 308 one or more of the plurality of image enhancement procedures to the identified regions to enhance a raster image of the complex bitmap image; and printing 310 the enhanced raster image.

By enhancing the window of data used by the template matching procedures to contain a superset of all image processing procedures (i.e., resolution enhancement, halftone image enhancement, resolution doubling and toner conservation procedures) there is enough information to dynamically switch between the procedures and apply any or all of the procedures to any given complex bitmap image. The image processing procedures that have simpler requirements, for example, binary matching rather than gray value matching, may be enhanced to detect the binary equivalent gray values (black and white values) where such procedures care about them and allow any gray value where they do not care about them. Thus, the invention allows for more dynamic (pixel by pixel basis) switching between image enhancement procedures. The invention allows, for example, resolution enhancement technology to smooth fine black and white edges in images, while toner conservation procedures may be used to reduce full black areas as well as reduce pixel size in midtone regions.

The plurality of image enhancement procedures may include resolution enhancement, halftone image enhancement, resolution doubling and toner conservation procedures. Toner conservation procedure may be used in conjunction with any of the other image enhancement procedures for any given complex bitmap image.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A method of enhancing a bitmap image that may include text, line art and halftone imagery comprising:
providing a set of image processing templates, each image processing template associated with one of a plurality of image enhancement procedures;
storing said bitmap image at a bit depth suitable for processing by each of said plurality of image enhancement procedures;
windowing said stored bitmap image with each said image processing template to identify matching regions in said bitmap image suitable for processing by said associated one said plurality of image enhancement procedures; and
selectively applying said associated one of said plurality of image enhancement procedures to each said identified region to generate an enhanced raster image of said bitmap image.

2. The method of claim 1, further comprising printing said enhanced raster image.

3. The method of claim 1, wherein said plurality of image enhancement procedures includes resolution enhancement, halftone image enhancement, resolution doubling and toner conservation procedures.

4. The method of claim 3, wherein all of said plurality of image enhancement procedures are applied to enhance print quality of said bitmap image.

5. A method of printing a bitmap image that may include text, line art and halftone imagery comprising:
providing a set of image processing templates, each template associated with one of a plurality of image enhancement procedures for improving image quality, said plurality of image enhancement procedures including a toner conservation procedure to reduce toner consumption;
storing said bitmap image at a bit depth suitable for processing by each of said plurality of image enhancement procedures;
windowing each said template over said stored bitmap image to identify regions in said bitmap image matching said template;
selectively applying said one associated of said plurality of image enhancement procedures to said identified regions to generate an enhanced raster image of said bitmap image; and
printing said enhanced raster image.

6. The method of claim 5, wherein said plurality of image enhancement procedures includes resolution enhancement technology (RET).

7. The method of claim 5, wherein said plurality of image enhancement procedures includes resolution doubling technology.

8. The method of claim 5, wherein said plurality of image enhancement procedures includes halftone image enhancing technology.

9. An apparatus for enhancing complex bitmap images comprising:
a memory for storing gray value image data;
a multiplexer with multiple inputs, a single output and a selection line;
text and line art enhancement circuitry coupled between said memory and a first of said multiple inputs of said multiplexer;
halftone image enhancement circuitry coupled between said memory and a second of said multiple inputs of said multiplexer;
toner conservation circuitry coupled between said memory and a third of said multiple inputs of said multiplexer; and
enhancement mode selection circuitry coupled between said memory and said selection line of said multiplexer for selectively engaging said text and line art enhancement circuitry, said halftone image enhancement circuitry and said toner conservation circuitry.

10. The apparatus of claim 9, further comprising a template database wherein said template database is a superset of templates representing all image processing modes requirements.

11. The apparatus of claim 9, wherein said apparatus is implemented in an application specific integrated circuit (ASIC).

12. A laser printer comprising:
a bus;
a processor connected to said bus;
a laser print engine connected to said bus; and
a first memory device comprising:
a halftone procedure;
a text and line art procedure;
a toner conservation procedure;
a resolution enhancement procedure;
a halftone enhancement procedure; and
a dynamic switching procedure for dynamically selecting and nonexclusively applying said toner conservation procedure, said resolution enhancement procedure and said halftone enhancement procedure to a complex bitmap image.

13. The laser printer of claim 12, further comprising a superset of templates controlled by said dynamic switching procedure representing mode requirements for said toner conservation procedure, said resolution enhancement procedure and said halftone enhancement procedure.

14. The laser printer of claim 13, wherein said superset of templates comprises a template database stored in said first memory device.

15. The laser printer of claim 13, wherein said superset of templates comprises a template database stored in a second memory device, said second memory device connected to said bus.

16. The laser printer of claim 12, wherein said resolution enhancement procedure includes resolution enhancement technology.

17. The laser printer of claim 12, wherein said resolution enhancement procedure includes resolution doubling technology.

18. The laser printer of claim 12, wherein said dynamic switching procedure is used for printing a complex bitmap image, said complex bitmap image may include text, line art and halftone imagery, said dynamic switching procedure comprising:
a superset of image processing templates configured for a plurality of image enhancement procedures said plurality of image enhancement procedures comprising said toner conservation procedure, said resolution enhancement procedure and said halftone enhancement procedure;
said complex bitmap image stored at a bit depth suitable for processing by all of said plurality of image enhancement procedures;
said superset of image processing templates windowed over said stored complex bitmap image to identify regions in said complex bitmap image suitable for processing by one or more of said plurality of image enhancement procedures;
one or more of said plurality of image enhancement procedures selectively applied to said identified regions to enhance a raster image of said complex bitmap image; and
said enhanced raster image being printed.

19. The laser printer of claim 18, wherein said resolution enhancement procedure includes resolution enhancement technology.

20. The laser printer of claim 19, wherein said dynamic switching procedure allows said resolution enhancement technology to smooth fine black and white edges in said stored complex bitmap image and simultaneously allows said toner conservation procedure to lighten full black areas in said stored complex bitmap image.

21. The laser printer of claim 18, wherein said resolution enhancement procedure includes resolution doubling technology.
